(19) United States
(12) Patent Application Publication
(10) Pub. No.: US 2010/0122620 A1
(43) Pub. Date: May 20, 2010

(54) CIRCULAR SAW BLADE WITH THERMAL BARRIER COATING

(75) Inventors: James P. Ruthven, Portland, OR (US); David S. Macey, Portland, OR (US)

Correspondence Address: STOEL RIVES LLP - PDX, 900 SW FIFTH AVENUE, SUITE 2600, PORTLAND, OR, 97204-1268, US

(73) Assignee: Pacific Saw and Knife Company LLC, Portland, OR (US)

(21) Appl. No.: 12/621,281

(22) Filed: Nov. 18, 2009

Related U.S. Application Data
(60) Provisional application No. 61/115,885, filed on Nov. 18, 2008.

(51) Int. Cl. B27B 33/08; B23D 61/02; B05D 5/00; B05D 1/08

(52) U.S. Cl. 83/835; 427/284; 427/448

(57) ABSTRACT

A circular saw blade includes a ceramic coating applied to opposing major surfaces in an outer margin of the circular saw blade where cutting teeth of the saw blade are arranged in spaced-apart relation and separated by blade tooth gullets. The ceramic coating inhibits abrupt increases in temperature of the outer margin during cutting operation to thereby inhibit the cutting teeth from deviating laterally. Methods of making saw blades include applying a ceramic coating to the outer margin using a plasma spray process or another coating process.

### RELATED APPLICATION

This application claims the benefit under 35 U.S.C. §119(e) of U.S. Provisional Application No. 61/115,885, filed Nov. 18, 2008, which is incorporated herein by reference.

### TECHNICAL FIELD

The present disclosure relates generally to cutting systems and more particularly to circular saw blades such as circular saw blades for lumber mills and methods of making circular saw blades.

### BACKGROUND INFORMATION

Circular saw systems for lumber mills are described in U.S. Pat. Nos. 3,285,302 and 3,623,520, incorporated herein by reference for background only. These patents describe gang saws having guide arms with wear pads formed of babbitt metal. The guide arms and wear pads improve the accuracy of the cut and reduce the size of the kerf by preventing the saw blade cutting edge from wandering laterally. The wear pads abut opposing sides of the blade radially inward from the outer margin of the blade where the cutting teeth are distributed. In conventional circular saw systems, sawdust spillage along the sides of the saw blade causes friction that tends to increase the temperature of its outer margin, which increases internal stresses that may cause the cutting edge to deviate laterally. Moreover, the gullets between the cutting teeth tend to wear over time, which increases sawdust spillage and exacerbates blade deviation. In some circumstances, an unacceptable amount of lateral deviation of the cutting edge occurs after only a few hours of operation.

### SUMMARY OF THE DISCLOSURE

According to one embodiment, a thermal barrier coating is applied to an outer margin of a circular saw blade to inhibit abrupt increases in temperature of the outer margin during cutting operation. The thermal barrier coating may be applied on opposing major surfaces of the circular saw blade in the outer margin. For example, the thermal barrier coating may cover opposing major surfaces of the cutting teeth. The thermal barrier coating may also cover the cutting edges of the cutting teeth and the blade tooth gullets that separate the cutting teeth. The thermal barrier coating may include a carbide and/or an oxide, and may be applied by using a plasma spray process or another coating process.

Additional aspects and advantages will be apparent from the following detailed description of preferred embodiments, which proceeds with reference to the accompanying drawings.

### BRIEF DESCRIPTION OF THE DRAWINGS

FIG. 1 is a side view of a saw blade and a guide arm of a saw blade system according to one or more embodiments.

FIG. 2 is a sectional view of the saw blade system taken along lines 2-2 of FIG. 1.

FIG. 3 is a perspective view of a portion of the outer margin of the saw blade of FIG. 1.

FIG. 4 is a sectional view of the saw blade taken along lines 4-4 of FIG. 3.

FIG. 5 is a flow chart of a coating process for depositing a thermal barrier coating on the saw blade of FIG. 1.

FIG. 6 is a side view of a portion of the outer margin of the saw blade of FIG. 1 showing tip inserts for the cutting edges of the blade.

### DETAILED DESCRIPTION OF PREFERRED EMBODIMENTS

With reference to the above-listed drawings, this section describes particular embodiments and their detailed construction and operation. The embodiments described herein are set forth by way of illustration only and not limitation. Those skilled in the art will recognize in light of the teachings herein that there is a range of equivalents to the example embodiments described herein. Most notably, other embodiments are possible, variations can be made to the embodiments described herein, and there may be equivalents to the components, parts, or steps that make up the described embodiments.

For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

According to one embodiment, a thermal barrier coating is applied to selected areas of a circular saw blade to inhibit the areas from heating up during cutting operation. For example, the thermal barrier coating is applied on opposing major surfaces of the circular saw blade at its outer margin to inhibit abrupt increases in temperature of the outer margin during cutting operation, which, in turn, inhibits the outer margin from deviating laterally. The circular saw blade may be used in a number of different applications including gang saws for lumber mills.

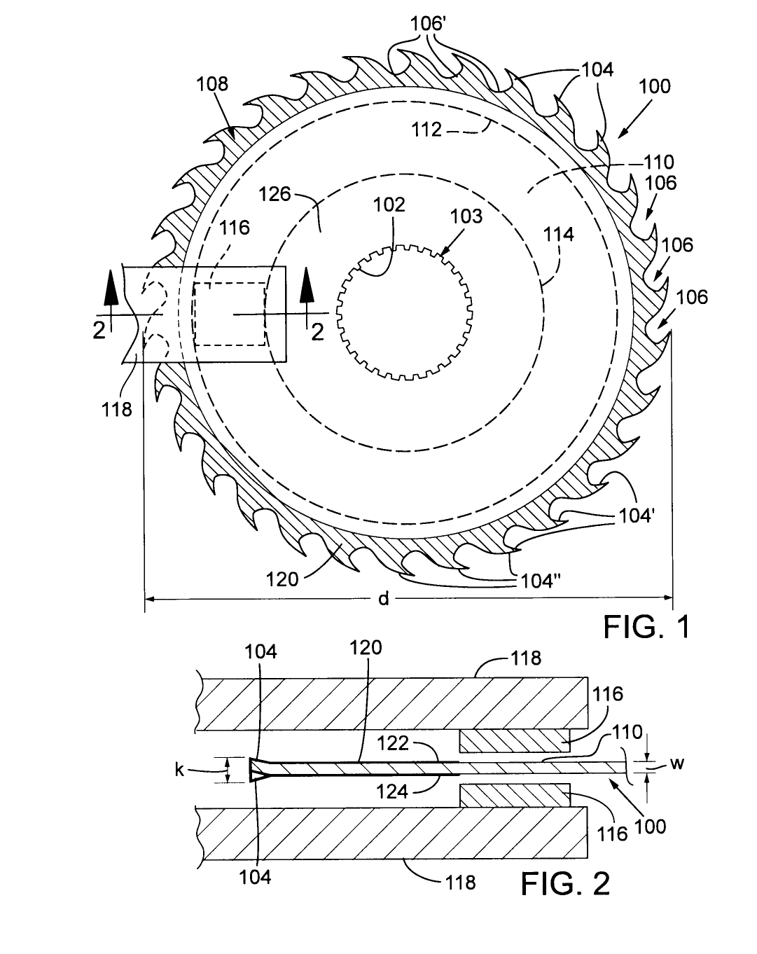

FIGS. 1 and 2 depict a circular saw blade 100 for cutting wood and the like according to an embodiment of the present disclosure. Blade 100 includes a core of a standard metal saw blade, for example of the kind used in gang saws of lumber mills. Blade 100 may be made of carbon or stainless steel having a standard plate hardness such as a hardness in the range of about RC 46 to RC 48 on the Rockwell hardness scale. Blade 100 includes a center opening 102 or “eye” sized and configured to mate with an arbor or shaft (not shown), which rotates blade 100 during cutting operation. In one example, center opening 102 may include splines 103 to mate with a complimentary splined arbor. A wide range of plate thicknesses and diameters may be selected for blade 100. For example, a plate thickness w may be in a range from about 0.1 to 0.76 centimeter (cm), preferably about 0.2 to 0.31 cm. A kerf size k produced by blade 100 will depend on many factors, including plate thickness w, tooth shape and set, and blade flatness, and may be in a range from about 0.6 to 3.6 millimeters (mm) greater than plate thickness w, typically about 0.76 to 1.27 mm greater than plate thickness w. Moreover, a diameter d may be in a range from about 10 to 200 cm. In one example, blade 100 may be a saw mill blade and its diameter d may be in a range from about 40 to 100 cm.

Blade 100 includes multiple cutting teeth 104 and blade tooth gullets 106 located in an outer margin 108, which is outboard of a region of contact 110 (area between lines 112 and 114) of wear pads 116 of guide arms 118. Although guide arms 118 and wear pads 116 are depicted in FIGS. 1 and 2, blade 100 may be used in applications in which guide arms 118 and wear pads 116 are not used. Cutting teeth 104 include cutting edges 104′ that may be an integral part of cutting teeth 104. Alternatively, cutting edges 104′ may be formed as part of conventional tip inserts 105 (see FIG. 6) made of stellite or another hard material, which are bonded to the ends of teeth 104, and may be replaced after they wear down. Blade 100 further includes a thermal barrier coating 120 (shown by hatching in FIGS. 1, 3, and 6) applied to at least a portion of opposing major surfaces 122 and 124 of blade 100 in outer margin 108.

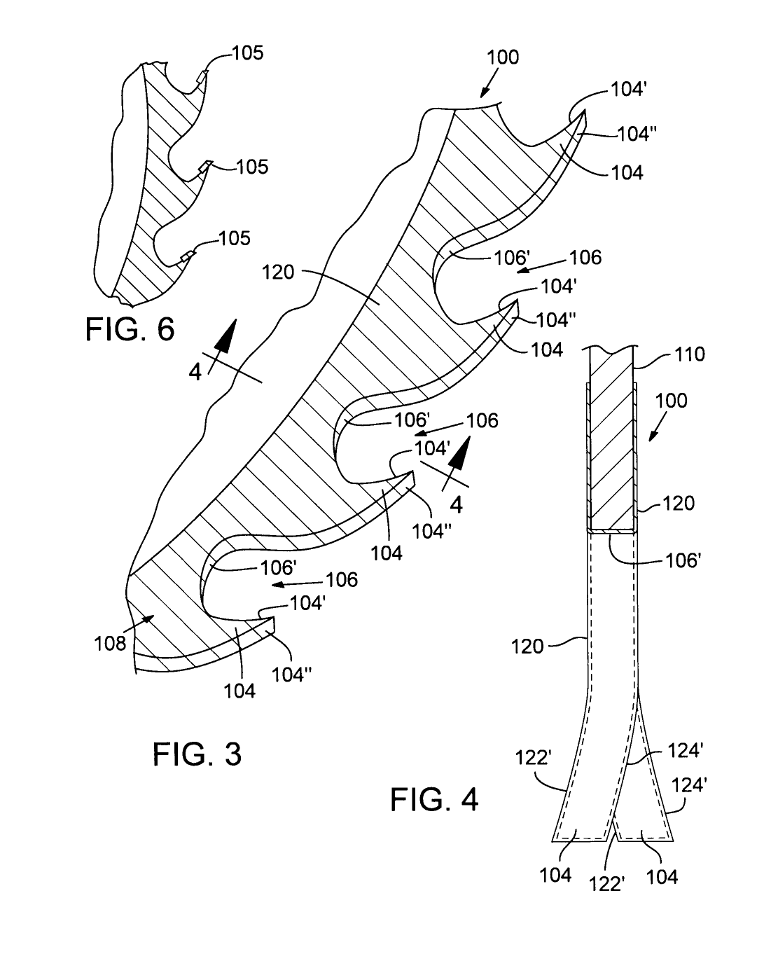

FIGS. 3 and 4 show thermal barrier coating 120 in more detail. In particular, thermal barrier coating 120 covers opposing major surfaces 122′ and 124′ of cutting teeth 104. Thermal barrier coating 110 may also cover cutting edges 104′ and outermost edges 104″ of cutting teeth 104 and gullet edges 106′ of gullets 106. In one example, tip inserts 105 for cutting edges 104′ are installed and thereafter thermal barrier coating 120 is applied to outer margin 108, including tip inserts 105. In an alternative example, uncoated or coated tip inserts 105 are installed on blade 100 after thermal barrier coating 120 has been applied to blade 100.

Thermal barrier coating 120 may be deposited in a ring, as shown in FIG. 1, on each surface 122 and 124 of blade 100 in outer margin 108. Thermal barrier coating 120 may be applied on opposing major surfaces 122 and 124 from outermost edges 104″ of cutting teeth 104 up to gullet edges 106′, up to the outer boundary 112 of the region of contact 110, or up to any dimension therebetween. In some embodiments, thermal barrier coating 120 may also be applied to a center portion 126 of the blade 100, located inboard of the region of contact 110. The region of contact 110 where wear pads 116 ride is left uncoated, to provide accurate and smooth bearing surfaces for the wear pads 116, and to allow blade 100 to be hammered, rolled, or otherwise mechanically leveled for reflattening after use without damaging thermal barrier coating 120. In one embodiment, the entire central region of the blade, from center opening 102 to within approximately 0.64 cm of gullet edges 106′ may be left uncoated to facilitate leveling the blade 100 by hammering, rolling, or otherwise.

Preferably, thermal barrier coating 120 includes a ceramic material. Suitable ceramic materials may include carbides, oxides, cermets, mullites, and combinations thereof. Examples of suitable carbides and/or cermets include WC—Co—Cr (example percentages 86/10/4), WC—Ni (example percentages 88/12), WC—CrC—Ni (example percentages 73/20/7), WC—Co (example percentages 88/12), Cr₃C₂—NiCr (example percentages 75/25), Mo₂C, WC—Co—NiSF, TiC, and Cr₃C₂. Examples of suitable oxides include Cr₂O₃ (e.g., 99.5% pure), Cr₂O₃—TiO₂ (example percentages 80/20), Cr₂O₃—TiO₂—SiO₂ (example percentages 92/3/5), Al₂O₃, Al₂O₃—TiO₂ (example percentages 97/3), and ZrO₂. In one example, thermal barrier coating 120 includes a spherical, hollow micro-balloon shaped mullite clad with nickel. Other ceramics such as nitrides, borides, and silicides may also be used for thermal barrier coating 120. In one example, thermal barrier coating 120 is relatively smooth and non-abrasive unlike coatings on tools used to grind and/or cut concrete, brick, metal, and other hard materials. Thermal barrier coating 120 may have a surface roughness in the range of about 0.2 to 10 μm Rₐ. In one example, thermal barrier coating 120 has a surface roughness below about 6 μm Rₐ. In another example, thermal barrier coating 120 has a surface roughness in a range from about 4 to 6 μm Rₐ. Surface roughness measurements are typically taken with a profilometer in accordance with a standard such as ISO 4287.

Blade 100, including the blade edges, may be stressed or tensioned so internal stresses at outer margin 108 are normally different than the internal stresses of the central regions (e.g., central portion 126, region of contact 110) of blade 100 when blade 100 is in a non-rotating state (i.e., when blade 100 is not spinning). For example, outer margin 108 may be put under tension by loosening or stretching the central regions of the blade 100 using hammering and/or rolling techniques (i.e., working the blade 100) prior to or after coating blade 100. Blade 100 may be tensioned to operate at a particular cutting speed. Blade 100 may be susceptible to temperature changes during use. For example, with an un-coated saw blade, sawdust chips that are smaller than the side clearance (e.g., (kerf size k−blade thickness w)/2) of the blade may spill out of the gullets onto opposing major surfaces of the outer margin causing it to heat up and deviate laterally due to expansion of the outer margin. In contrast, thermal barrier coating 120 provides a thermal barrier layer that inhibits abrupt increases in temperature of the metal blade core at outer margin 108 that may otherwise result in an imbalance in internal blade stresses leading to lateral deviation of the outer margin 108. Reduced deviation of outer margin 108 reduces the kerf size k cut by the blade 100 and/or helps to maintain a relatively straight cut, thereby improving cutting accuracy and reducing waste. Reduced deviation also reduces sawdust spillage from gullets 106, thereby reducing friction and blade wear, and associated blade changes and equipment downtime. In one example, thermal barrier coating 120 has a thermal conductivity below that of steel. In another example, thermal barrier coating 120 has a thermal conductivity below about 120 watts per meter-kelvin W/(mK). In another example, thermal barrier coating 120 has a thermal conductivity below about 85 W/(mK). In another example, thermal barrier coating 120 has a thermal conductivity below about 50 W/(mK). In another example, thermal barrier coating 120 has a thermal conductivity below about 30 W/(mK). In another example, thermal barrier coating 120 has a thermal conductivity below about 20 W/(mK). In another example, thermal barrier coating 120 has a thermal conductivity below about 10 W/(mK). In another example, thermal barrier coating 120 has a thermal conductivity in a range from about 0.35-1.0 W/(mK).

In addition to providing a thermal barrier, thermal barrier coating 120 may also provide a wear coating for cutting teeth 104 and gullet edges 106′. For example, thermal barrier coating 120 may inhibit gullet edges 106′ from wearing down over time to thereby reduce sawdust spillage and friction. Moreover, thermal barrier coating 120 may be sufficiently strong and well bonded to blade 100 to withstand wearing away from opposing major surfaces 122 and 124 over time so that blade 100 may continue to provide thermal protection for outer margin 108 even after extended use. For example, thermal barrier coating 120 may have a hardness in a range from about 1000 to 1500 in the Vickers hardness scale. In one example, thermal barrier coating 120 has a hardness in a range from about 1250 to 1350 in the Vickers hardness scale. In another example, thermal barrier coating 120 has a hardness in a range from about 1300 to 1400 in the Vickers hardness scale, and in another example thermal barrier coating 120 has a hardness in a range from about 1100 to 1200 in the Vickers hardness scale.

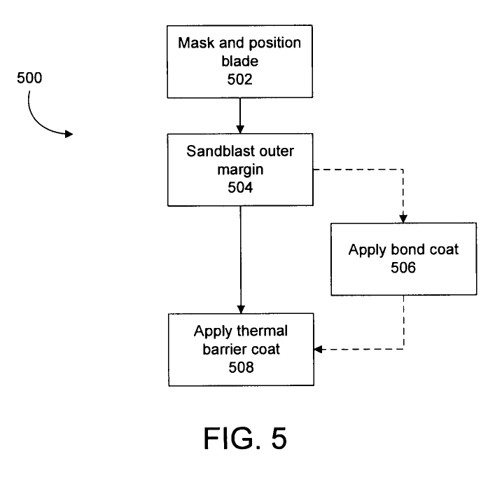

FIG. 5 is a flow chart of a method 500 that may be used to coat blade 100 according to one embodiment. Although method 500 corresponds to a plasma spray process, other techniques, such as solution processing, chemical vapor deposition (CVD), physical vapor deposition (PVD), and high-velocity oxy-fuel coating (HVOF), may be used to deposit thermal barrier coating 120 on blade 100. First, blade 100 is masked to cover the regions that are to remain uncoated (e.g., the region of contact 110) and positioned in an arbor (not shown) to allow blade 100 and mask (not shown) to rotate to facilitate application of thermal barrier coating 120 (step 502). The exposed surfaces of outer margin 108 are then sandblasted to roughen them so that thermal barrier coating 120 can bond well to blade 100 (step 504). An initial bond coating may optionally be applied to serve as an interface between the sandblasted outer margin 108 and the ceramic coating (step 506). Preferably, the bond coating is applied when a ceramic oxide is used for thermal barrier coating 120. The bond coating functions to hold ceramic oxide to the blade 100. One example of a suitable bond coating is NiCr (example percentages 80/20). The initial bond coating may be applied using a plasma spray gun. When carbide ceramic is used, thermal barrier coating 120 can be applied without applying the initial bond coating.

After step 504 or step 506, thermal barrier coating 120 is applied on outer margin 108 (step 508). For example, a plasma spray process may be used in which a plasma gas such as argon, nitrogen, hydrogen or a mixture thereof that is inert to the materials that will form thermal barrier coating 120 is dissociated and accelerated in a nozzle of a plasma gun (also called a plasma arc or plasma torch) through expansion to thereby generate a plasma gas stream (also called a plasma flame). The plasma gas stream is directed toward a deposition site at outer margin 108. A powder (e.g., carbide powder, oxide powder, mullite powder) is introduced into the plasma gas stream and high temperatures (e.g., up to 20,000 K) of the plasma gas stream melt the powder, and the melted powder is propelled toward the deposition site. The melted powder impacts the deposition site to form thermal barrier coating 120. The nozzle of the plasma gun may be moveable (e.g., via a robotic control system) to provide an even coat on blade 100. Moreover, blade 100 may be rotated on the arbor in concert with movement of the plasma gun to evenly coat gullet edges 106′, opposing major surfaces 122 and 124, and cutting edges 104′. The plasma spray process provides good bond strength for thermal barrier coating 120 and allows a thin, even coat to be applied. For example, the ceramic coating 102 may have a thickness from about 10 μm to about 500 μm. In one example, the thermal barrier coating 120 has a thickness a range from about 35 to 255 μm. In another example, the thermal barrier coating 120 has a thickness of in a range from about 50 to 70 μm.

Thermal barrier coating 120 is capable of significantly reducing lateral deviation of the outer margin 108 during cutting operation. For example, a first gang of 10 un-coated saw blades and a second gang of 10 coated saw blades were used to cut Douglas fir wood. The saw blade specifications and operating conditions for each of the first and second gangs of saw blades are listed in the following table:

| blade diameter d | 62.2 | cm |
|---|---|---|
| plate thickness w | 0.28 | cm |
| original kerf size k | 0.38 | cm |
| cutting speed | 2400 | rpm |
| depth of cut | 20.3 | cm |
| wood type | Douglas fir | |
| feed rate | 200 | feet-per-minute (fpm) |

The thermal barrier coating 120 on the blades of the second gang included WC—Co—Cr (86/10/4) and was applied to outer margins 108 of the blades using a plasma spray process. The thermal barrier coating 120 was approximately 64 μm thick per side and covered the opposing major surfaces 122′ and 124′ of the blade teeth 104 from their outermost edges 104″ to approximately 0.64 cm radially inward from the gullet edges 106′. The thermal barrier coating 120 also covered the gullet edges 106′ and the cutting edges 104′ of the cutting teeth 104.

After approximately two hours of continuous run time, the outer margins of the blades of gang 1 deviated laterally or wobbled side-to-side by unacceptable amounts producing a wider kerf size k, a crooked cut, or both. In some applications, a kerf size k that increases by more than about 0.5 to 1.3 mm is unacceptable. Moreover, in some applications, cuts that deviated by more than about ±0.25 to 0.63 mm from their nominal positions are unacceptable. After two hours the blades of gang 1 needed to be changed, which required approximately 20 minutes of unscheduled equipment downtime, or approximately 80 minutes of downtime on average for a ten-hour shift. The blades also required extra maintenance work to re-level and re-tension them for future runs.

On the other hand, the coated blades of gang 2 operated continuously for a ten-hour shift, during which the kerf size k and lateral deviations of the cuts remained within acceptable ranges. Acceptable ranges for lateral deviation of a cut and an increase in kerf size k may depend on the type of application in which blade 100 is used. In some applications, lateral deviation of a cut of less than about ±0.25 mm from its nominal position may be acceptable. In one example, the lateral deviation of a cut from its nominal position may be less than about ±0.13 mm, and in another example, the lateral deviation may be less than about ±0.064 mm. Moreover, in some applications an increase in the kerf size k of less than about 0.5 mm may be acceptable. In one example, an increase in the kerf size k of less than about 0.25 mm may be acceptable, an in another example, an increase in the kerf size k of less than about 0.13 mm may be acceptable. After the shift, the coated blades needed no extra maintenance work aside from standard re-sharpening of the cutting edges 104′. Accordingly, the coated blades were able to prevent a substantial amount of unscheduled equipment downtime and blade repair time.

It will be obvious to skilled persons the art that many changes may be made to the details of the above-described embodiments without departing from the underlying principles of the invention. The scope of the present invention should, therefore, be determined only by the following claims.

1. A circular saw blade for cutting cellulosic material, comprising:
a circular metal blade core having opposing major surfaces, an outer margin, and a region on each of the opposing major surfaces radially inward from the outer margin, the outer margin including cutting teeth separated by blade tooth gullets; and
a ceramic coating deposited on the opposing major surfaces in the outer margin, the regions on the opposing major surfaces being uncoated with the ceramic coating, the ceramic coating providing a thermal barrier layer that inhibits an abrupt change in temperature of the outer margin during cutting operation to thereby inhibit lateral deviation of the cutting teeth.

2. The circular saw blade of claim 1, in which the ceramic coating covers an area of the outer margin from an outermost edge of the blade teeth to between about 0.1 cm to about 3 cm inboard the bade tooth gullets.

3. The circular saw blade of claim 1, in which the ceramic coating has a thickness from about 35 μm to about 255 μm.

4. The circular saw blade of claim 1, in which the ceramic coating forms a ring on each of the opposing major surfaces in the outer margin.

5. The circular saw blade of claim 1, in which each of the blade tooth gullets is defined by a gullet edge and the ceramic coating covers the gullet edges and provides a wear barrier to inhibit wearing of the gullet edges.

6. The circular saw blade of claim 1, in which the blade teeth include opposing major surfaces and the ceramic coating covers the opposing major surfaces of the blade teeth.

7. The circular saw blade of claim 1, in which the blade teeth include tip inserts that are uncoated with the ceramic coating.

8. The circular saw blade of claim 1, in which the ceramic coating includes a carbide.

9. The circular saw blade of claim 1, in which the ceramic coating includes an oxide.

10. The circular saw blade of claim 1, in which the ceramic coating is substantially non-abrasive.

11. The circular saw blade of claim 1, in which the ceramic coating has a surface roughness in a range from about 4 μm Rₐ to about 6 μm Rₐ.

12. The circular saw blade of claim 1, in which the uncoated regions radially inward from the outer margin are sized to accommodate wear pads.

13. The circular saw blade of claim 1, in which the outer margin is under tension when the circular saw blade is in a non-rotating state.

14. A method of producing a circular saw, comprising:
providing a circular metal blade core having opposing major surfaces, an outer margin, and a region on each of the opposing major surfaces radially inward from the outer margin, the outer margin including cutting teeth separated by blade tooth gullets; and
depositing a ceramic coating on the opposing major surfaces in the outer margin, the regions radially inward from the outer margin being left uncoated with the ceramic coating, the ceramic coating providing a thermal barrier layer that inhibits an abrupt change in temperature of the outer margin during cutting operation to thereby inhibit lateral deviation of the cutting teeth.

15. The method of claim 14, in which the blade tooth gullets are defined by gullet edges, and further comprising depositing the ceramic coating on the gullet edges.

16. The method of claim 14, in which the cutting teeth include tip inserts, and further comprising depositing the thermal barrier coating on the tip inserts.

17. The method of claim 14, in which the ceramic coating is deposited using a plasma spray process.

18. The method of claim 14, further comprising masking the circular metal blade core so that the outer margin is exposed.

19. The method of claim 18, further comprising sandblasting the exposed outer margin.

20. The method of claim 19, further comprising depositing a bond coating on the exposed outer margin before depositing the ceramic coating.

21. The method of claim 14, further comprising:
generating a plasma gas stream directed at a deposition site at the outer margin; and
introducing a ceramic powder in the plasma gas stream to thereby melt and propel the ceramic powder toward the deposition site.

22. The method of claim 14, further comprising depositing the ceramic coating in the outer margin until the ceramic coating has a thickness from about 35 μm to about 255 μm.

23. The method of claim 14, in which, prior to depositing the ceramic coating, the outer margin is put under tension by working the region radially inward from the outer margin.
